(19) United States
(12) Patent Application Publication
(10) Pub. No.: US 2012/0230590 A1
(43) Pub. Date: Sep. 13, 2012

(54) IMAGE PROCESSING APPARATUS, NON-TRANSITORY COMPUTER-READABLE MEDIUM, AND IMAGE PROCESSING METHOD

(75) Inventors: Zhenrui ZHANG, Kanagawa (JP); Hiroyoshi UEJO, Kanagawa (JP); Kazuhiro OHYA, Kanagawa (JP); Katsuya KOYANAGI, Kanagawa (JP); Shigeru OKADA, Kanagawa (JP); Minoru SODEURA, Kanagawa (JP); Shintaro ADACHI, Kanagawa (JP)

(73) Assignee: FUJI XEROX CO., LTD., TOKYO (JP)

(21) Appl. No.: 13/287,524

(22) Filed: Nov. 2, 2011

(30) Foreign Application Priority Data
Mar. 11, 2011 (JP) 2011-053976

(51) Int. Cl. G06K 9/46

(52) U.S. Cl. 382/195

(57) ABSTRACT

An image processing apparatus includes a registering unit that registers a first language and a second language different from the first language, a character string extracting unit that extracts one or more character strings from reading information acquired by reading an original, plural feature character string creating sections that create a feature character string of the original on the basis of the one or more character strings extracted by the character string extracting unit, and a switching unit that switches the feature character string creating section used to create the feature character string on the basis of a combination of the registered first language and the registered second language.

### CROSS-REFERENCE TO RELATED APPLICATIONS

This application is based on and claims priority under 35 USC 119 from Japanese Patent Application No. 2011-053976 filed Mar. 11, 2011.

### BACKGROUND

### Technical Field

The present invention relates to an image processing apparatus, a non-transitory computer-readable medium, and an image processing method.

### SUMMARY

According to an aspect of the invention, there is provided an image processing apparatus including: a registering unit that registers a first language and a second language different from the first language; a character string extracting unit that extracts one or more character strings from reading information acquired by reading an original; plural feature character string creating sections that create a feature character string of the original on the basis of the one or more character strings extracted by the character string extracting unit; and a switching unit that switches the feature character string creating section used to create the feature character string on the basis of a combination of the registered first language and the registered second language.

### BRIEF DESCRIPTION OF THE DRAWINGS

Exemplary embodiments of the present invention will be described in detail based on the following figures, wherein:

FIG. 1 is a diagram illustrating the hardware configuration of an image processing apparatus according to an exemplary embodiment of the invention;

FIG. 2 is a diagram illustrating a processing program operating in the image processing apparatus shown in FIG. 1;

FIG. 3 is a diagram illustrating the configuration of a feature character string creating unit shown in FIG. 2;

FIG. 4 is a diagram illustrating a character string list stored in an extracted character string managing unit shown in FIG. 2;

FIGS. 5A to 5G are diagrams illustrating a switching table;

FIG. 6 is a flowchart illustrating a flow of processes of the processing program;

FIGS. 7A and 7B are diagrams illustrating an example of an original to be processed in the image processing apparatus according to the exemplary embodiment and an example of an extraction result of character strings, respectively;

FIG. 8 is a diagram illustrating a process of the feature character string creating unit when a reader language of the original shown in FIGS. 7A and 7B is Japanese;

FIG. 9 is a diagram illustrating a process of the feature character string creating unit when the reader language of the original shown in FIGS. 7A and 7B is Chinese;

FIG. 10 is a diagram illustrating a process of the feature character string creating unit when the reader language of the original shown in FIGS. 7A and 7B is Korean; and

FIG. 11 is a diagram illustrating a process of the feature character string creating unit when the reader language of the original shown in FIGS. 7A and 7B is Chinese.

### DETAILED DESCRIPTION

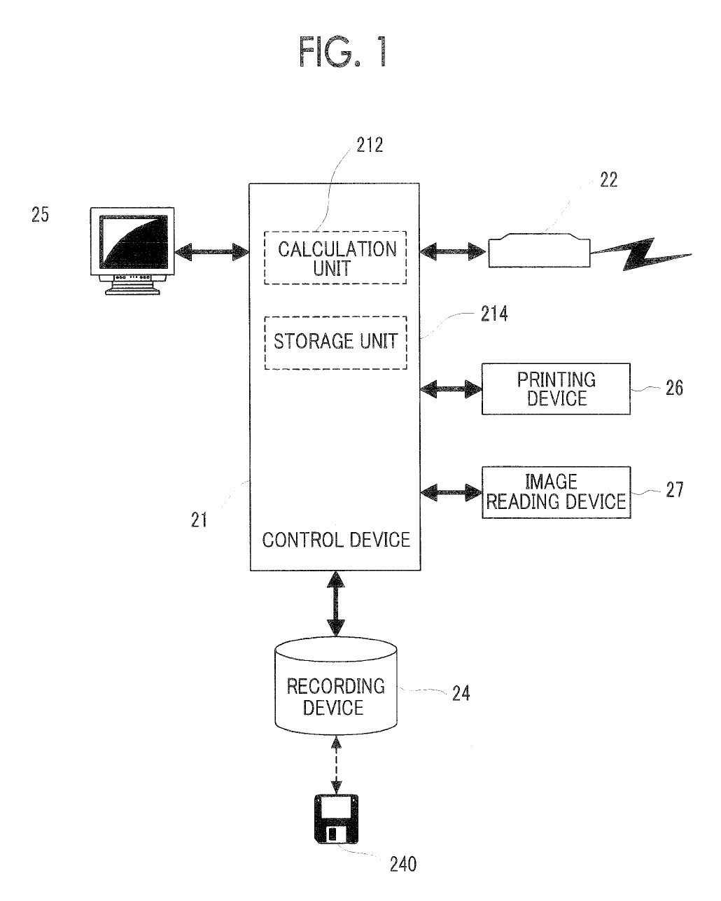

FIG. 1 is a diagram illustrating the hardware configuration of an image processing apparatus 2 according to an exemplary embodiment of the invention.

As shown in FIG. 1, the image processing apparatus 2 includes a control device 21 including a calculation unit 212 such as a CPU and a storage unit 124 such as a memory, a communication device 22, a recording device 24, a user interface (UI) device 25, a printing device 26, and an image reading device 27.

The UI device 25 includes a display device such as an LCD (Liquid Crystal Display) display device or a CRT (Cathode Ray Tube) display device, a keyboard, and a touch panel.

The printing device 26 is, for example, a printer and prints character data or image data on a recording medium such as a sheet of paper.

The image reading device 27 is, for example, a scanner and reads an image from a recording medium such as an original and converts the read image into, for example, reading information in a bitmap format.

That is, the image processing apparatus 2 has a hardware constituent component as a computer which can perform an information process and which can communicate with another image processing apparatus or terminal.

In the drawings to be described below, substantially the same constituents and processes are referenced by the same reference numbers and signs.

It is stated in this exemplary embodiment that the image processing apparatus 2 includes the printing device 26 and the image reading device 27, but the image processing apparatus may be, for example, a PC not including a printing device and an image reading device. In this case, the image processing apparatus may be connected to an image reading device via a LAN (Local Area Network) or the like.

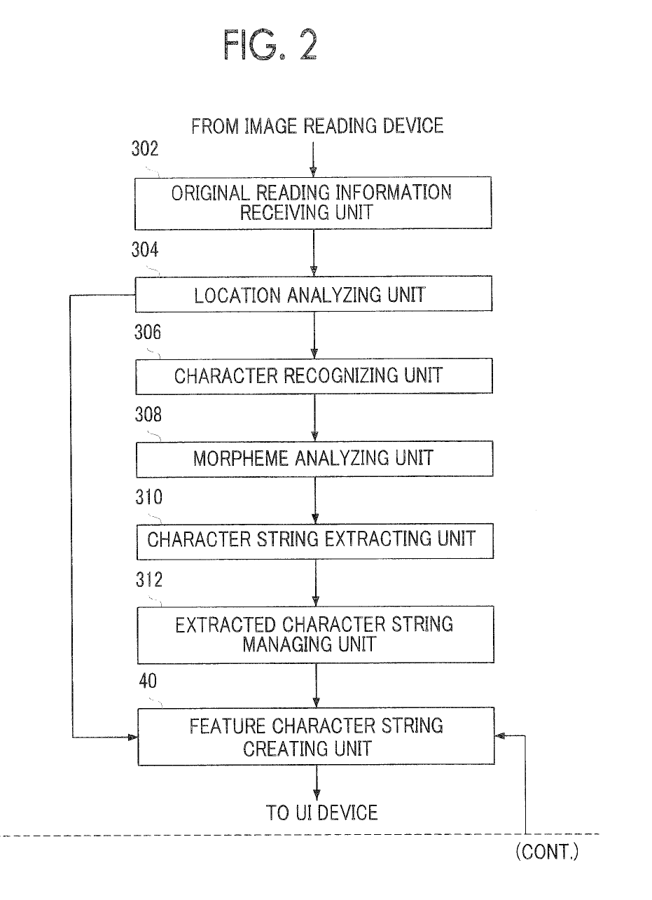

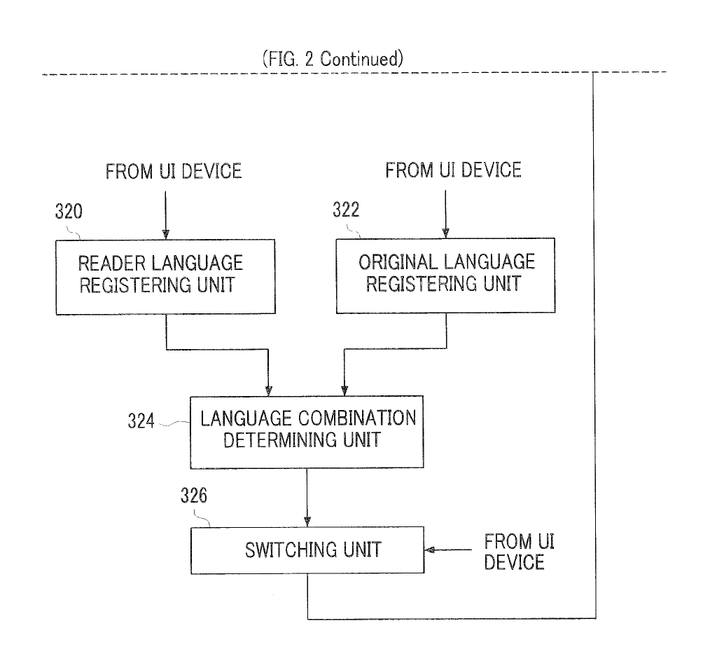

FIG. 2 is a diagram illustrating the configuration of a processing program 3 operating in the image processing apparatus 2 shown in FIG. 1.

As shown in FIG. 2, the processing program 3 includes an original reading information receiving unit 302, a location analyzing unit 304, a character recognizing unit 306, a morpheme analyzing unit 308, a character string extracting unit 310, an extracted character string managing unit 312, a reader language registering unit 320, an original language registering unit 322, a language combination determining unit 324, a switching unit 326, and a feature character string creating unit 40.

The processing program 3 is provided to the image processing apparatus 2 via a storage medium 240 (FIG. 1), is loaded into the storage unit 214, and is executed over an OS (not shown) installed in the image processing apparatus 2 specifically using the hardware resources of the image processing apparatus 2.

It is stated in this exemplary embodiment that the functions of the processing program 3 are embodied by software, but all or a part of the functions of the processing program 3 may be embodied by hardware such as FPGA (Field Programmable Gate Array).

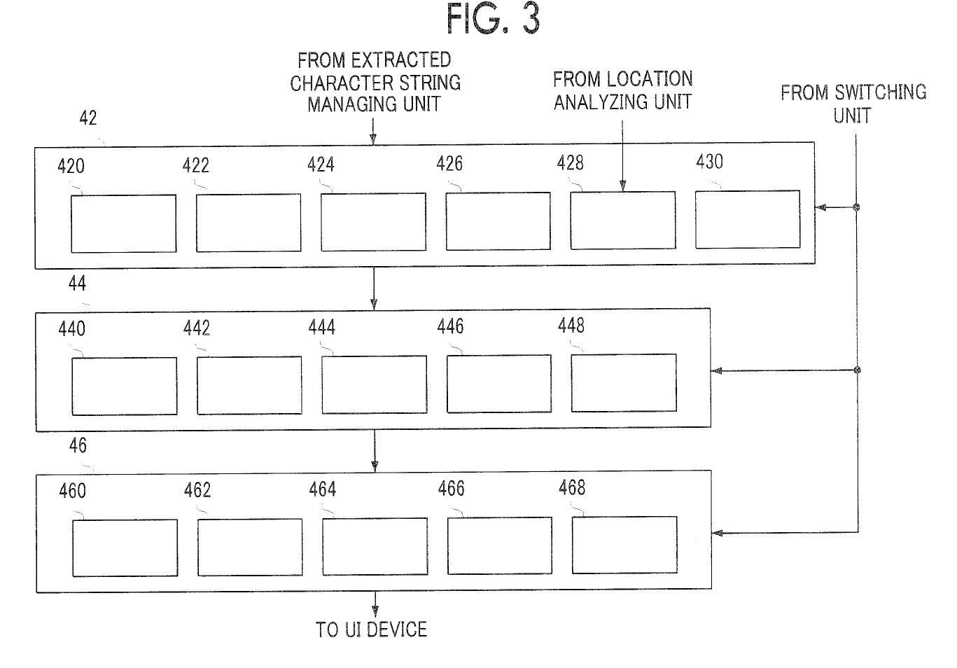

FIG. 3 is a diagram illustrating the configuration of the feature character string creating unit 40 shown in FIG. 2.

Here, a “feature character string” is a character string used for a user to identify an original and is, for example, the name of electronic data or a path folder (directory) storing the electronic data when the original is converted into the electronic data (an electronic file).

As shown in FIG. 3, the feature character string creating unit 40 includes a constituent selecting unit 42, a constituent converting unit 44, and a feature character string determining unit 46.

The constituent selecting unit 42 includes an appearance frequency preferentially-selecting section 420, a reader language preferentially-selecting section 422, a complex character string preferentially-selecting section 424, a position/scale preferentially-selecting section 426, a location element preferentially-selecting section 428, and a manual selection section 430.

The constituent converting unit 44 includes a translation section 440, a phonetic transcription section 442, a character code converting section 444, a non-conversion section 446, and a manual conversion section 448.

The feature character string determining unit 46 includes a link sign insertion coupling section 460, a head character conversion coupling section 462, a non-conversion coupling section 464, an order change coupling section 466, and a manual coupling section 468.

The constituent selecting unit 42, the constituent converting unit 44, and the feature character string determining unit 46, which constitute the feature character string creating unit 40, may also be referred to as “feature character string creating sections”.

Similarly, the appearance frequency preferentially-selecting section 420, the reader language preferentially-selecting section 422, the complex character string preferentially-selecting section 424, the position/scale preferentially-selecting section 426, the location element preferentially-selecting section 428, and the manual selection section 430 constituting the constituent selecting unit 42, the translation section 440, the phonetic transcription section 442, the character code converting section 444, the non-conversion section 446, and the manual conversion section 448 constituting the constituent converting unit 44, and the link sign insertion coupling section 460, the head character conversion coupling section 462, the non-conversion coupling section 464, the order change coupling section 466, and the manual coupling section 468 constituting the feature character string determining unit 46 may also be referred to as the “feature character string creating sections”.

In the processing program 3 (FIG. 2), the original reading information receiving unit 302 receives reading information (original reading information) acquired from the image reading device 27 and stores the received original reading information so as to be provided for the process of the location analyzing unit 304.

The location analyzing unit 304 analyzes the original reading information, classifies natural images such as characters, tables, and photographs located in the original, computer graphics (CG), or paintings (classifies objects), specifies areas of the classified objects (natural images such as characters, tables, and photographs, CGs, or paintings, which are hereinafter referred to as “location elements”), and correlates position information with the location elements.

The location analyzing unit 304 outputs information representing the analysis result as location information to the character recognizing unit 306 and the feature character string creating unit 40.

Here, the location information is information representing what objects are located in the original corresponding to the original reading information and at what positions and with what scales the objects are located.

The “location information” includes position information representing the positions of the location elements and scale information representing the scales (sizes or areas) of the location elements.

Here, the position information may represent the absolute position such as positional coordinates or may represent the relative positional relationship to another character string.

Similarly, the scale information may represent the absolute scale of a location element such as a font or an occupied area, or may represent the relative scale to another location element, or may represent the difference from the average value of the scales of the location elements.

The classification of the location elements by the location analyzing unit 304 is performed, for example, by detection of various lines, frame borders, and ruled lines or color information located in the original, detection of edges, and pattern matching. However, the classification is not limited to these methods.

The character recognizing unit 306 recognizes characters by specifying the areas in which characters are described from the location information and performing, for example, an OCR (Optical Character Recognition) function on the areas (character areas).

Here, the recognition of characters means that characters acquired by reading are specified and character data is created by combining image data of the characters with previously-stored patterns.

The character recognizing unit 306 outputs the created character data to the morpheme analyzing unit 308.

Here, the character data (and character strings to be described later) can be expressed by character codes such as shift JIS codes, ASCII (American Standard Code for Information Interchange) codes, or unicodes.

Here, the character codes are codes (indicating the correspondence) representing characters and sentences when the characters are not treated as graphic data such as images but treated as text data in an electronic medium such as a computer.

The morpheme analyzing unit 308 divides a sentence represented by character data into morphemes (character strings) by performing a morpheme analysis process on the character data recognized by the character recognizing unit 306, and gives attribute information to the divided morphemes.

The morpheme analyzing unit 308 outputs a group (character string group) of character strings to which the attribute information is given to the character string extracting unit 310.

Here, the morpheme analysis means a process of dividing a sentence into character strings which are morphemes (smallest units of language having a meaning) and determining word classes of the divided morphemes (character strings) on the basis of information of grammatical rules stored in advance and a dictionary in which words are registered.

In this morpheme analysis process, the language of the character strings is also determined (it is determined what language of Japanese, English, Chinese, Korean, and other languages the character strings are).

In the morpheme analysis process, it is determined whether a character string is a complex character string.

Here, the complex character string means a character string including plural words.

For example, since a character string “market size” includes two words “market” and “size”, it is determined to be a complex character string.

The attribute information is information representing the attribute of a character string such as the word class (noun, verb, and the like) of the character string and the language of the character string and includes character string word class information representing the word class of the character string and character string language information representing the language of the character string.

When a character string is a complex character string, the attribute information includes information (complex character string information) representing the fact that the character string is a complex character string.

The character string extracting unit 310 extracts character strings to which predetermined specified attribute information is given from a character string group input from the morpheme analyzing unit 308.

The character string extracting unit 310 orders the extracted character strings on the basis of a predetermined criterion and enumerates the extracted character strings in the order.

The character string extracting unit 310 outputs a list of the enumerated character strings (character string list) to the extracted character string managing unit 312.

The extracted character string managing unit 312 stores the character string list from the character string extracting unit 310 and manages the character string list to be provided for the process in the feature character string creating unit 40.

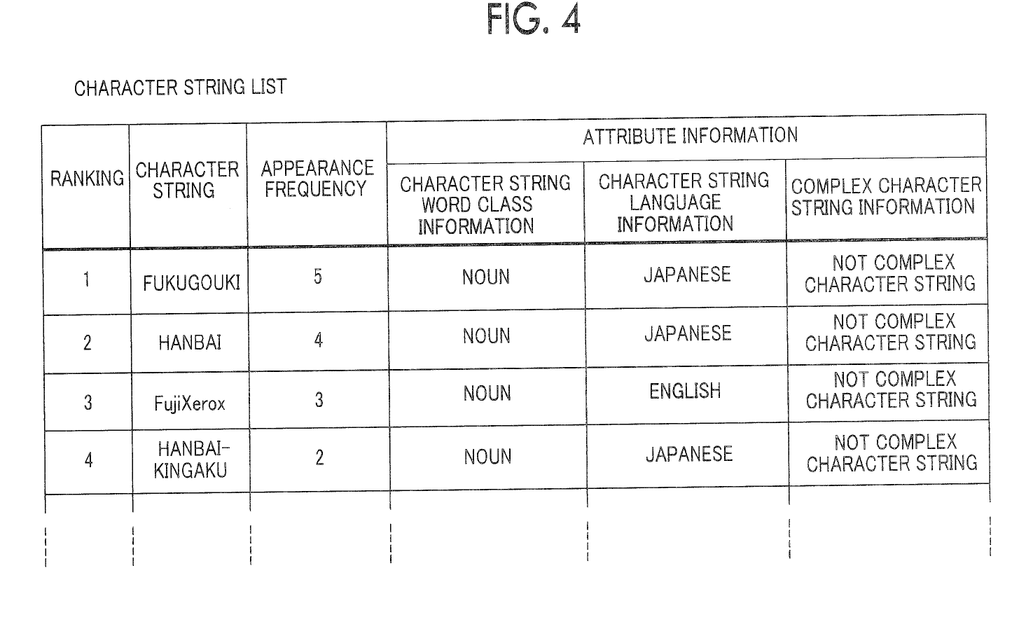

FIG. 4 is a diagram illustrating a character string list stored in the extracted character string managing unit 312 shown in FIG. 2.

As shown in FIG. 4, the character string list includes character strings and the ranking of appearance frequency, appearance frequency, and attribute information of the respective character strings. The attribute information includes character string word class information, character string language information, and complex character string information.

In the example shown in FIG. 4, the ranking of a character string “fukugouki” is 1, the appearance frequency thereof is 5, the word class thereof is “noun”, the language thereof is “Japanese”, and the character string is not a complex character string.

The ranking of a character string “FujiXerox” is 3, the appearance frequency thereof is 3, the word class thereof is “noun”, the language thereof is “English”, and the character string is a complex character string.

The character string extracting unit 310 (FIG. 2) may extract, for example, character strings to which attribute information including character string word class information indicating a noun is given from the character string group.

For example, the character string extracting unit 310 may enumerate the character strings sequentially from the character string having the largest number of frequencies (appearance frequency) with which the character string appears in the original.

Here, the character string extracting unit 310 may not enumerate character strings having an appearance frequency equal to or lower than a predetermined number or character strings having a ranking of appearance frequency lower than a predetermined ranking but may skip the character strings.

The character string extracting unit 310 may give a weighting factor indicating a weight corresponding to the appearance frequency or the ranking of the character strings to the character strings when enumerating the character strings.

For example, when the appearance frequency of the character string “fukugouki” is the highest, the appearance frequency of the character string “hanbai” is the second highest, and the appearance frequency of the character string “denpyo” is the third highest, the character string extracting unit 310 may give a weight factor 10.0 to the character string “fukugouki”, may give a weight factor 8.0 to the character string “hanbai”, and may give a weighting factor 6.0 to the character string “denpyo”.

The character string extracting unit 310 may enumerate the character strings on the basis of the grammatical rule or may enumerate the character strings on the basis of prescribed attributes of words.

For example, the character string extracting unit 310 may enumerate the character strings on the basis of the types of nouns such as a common noun or a proper noun or may enumerate a character string serving as a subject in a sentence of a high ranking.

The criterion used for the character string extracting unit 310 to order the character strings may be changed by the switching unit 326 to be described later.

The reader language registering unit 320 registers a language (reader language) which can be recognized by a reader of an original and outputs information (reader language information) indicating the registered reader language to the language combination determining unit 324.

For example, when a reader of an original can recognize Japanese, the reader language is Japanese. When a reader of an original can recognize Chinese, the reader language is Chinese.

The reader language registering unit 320 may register a reader language, for example, by receiving reader language information, which is acquired by a user's operation on the UI device 25, from the UI device 25.

The reader language registering unit 320 may register a reader language without causing a user to operate the UI device 25.

For example, the reader language registering unit 320 stores a reader language table in which identification information of readers and reader languages are correlated with each other in advance and may register the reader language by combining the reader language table with identification information of a reader, which is acquired by causing an identification carder reading device (not shown) to read a reader's identification card.

When the image processing apparatus 2 is installed in a reader's surrounding such as when the reader of an original is equal to the user of the image processing apparatus 2, the image processing apparatus 2 may store the reader language information in advance and may register the reader language on the basis of the stored reader language information. When the identification information of a reader is embedded in an original in advance such as when a reader name of an original is described in the original, the character recognizing unit 306 may acquire a character string corresponding to the reader identification information by recognizing the embedded reader identification information by character recognition and the reader language registering unit 320 may register the reader language by combining the reader language table with the character string corresponding to the acquired reader identification information.

The reader language registering unit 320 may register plural reader languages when plural readers read the original.

The original language registering unit 322 registers the language of an original (original language) and outputs information (original language information) indicating the registered original language to the language combination determining unit 324.

For example, the original language is Japanese when the ratio of the characters strings of which the language is Japanese out of the character strings appearing in the original is the largest, and the original language is Chinese when the ratio of the character strings of which the language is Chinese is the largest.

The original language registering unit 322 may register the original language, for example, by receiving original language information, which is acquired by a user's operation on the UI device 25, from the UI device 25.

The original language registering unit 322 may register the original language without causing a user to operate the UT device 25.

For example, the morpheme analyzing unit 308 may determine the languages of the character strings appearing in the original and the original language registering unit 322 may register the original language by determining the language of which the character strings appear at the largest ratio.

The language combination determining unit 324 determines a combination of a reader language and an original language on the basis of the reader language information from the reader language registering unit 320 and the original language information from the original language registering unit 322.

The language combination determining unit 324 outputs information (language combination information) indicating the combination of a reader language and an original language to the switching unit 326.

The switching unit 326 switches a feature character string creating section used to create a feature character string in the feature character string creating unit 40 on the basis of the language combination information from the language combination determining unit 324.

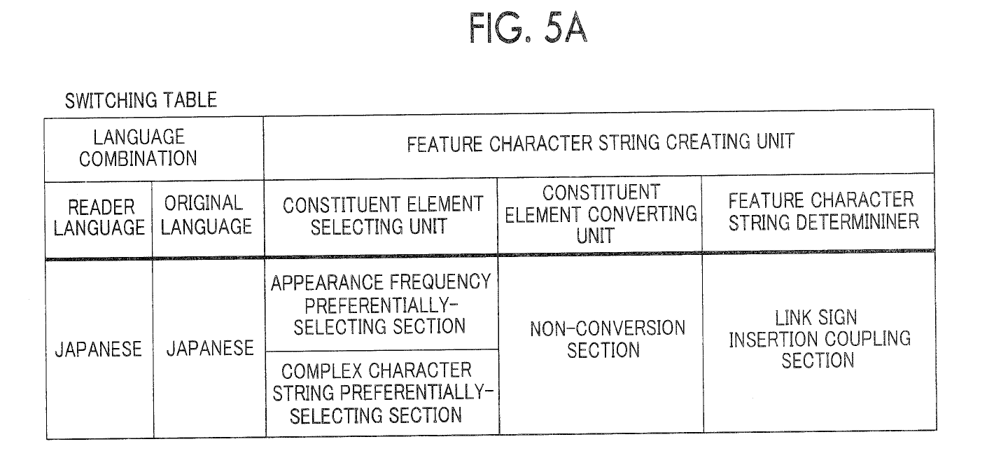

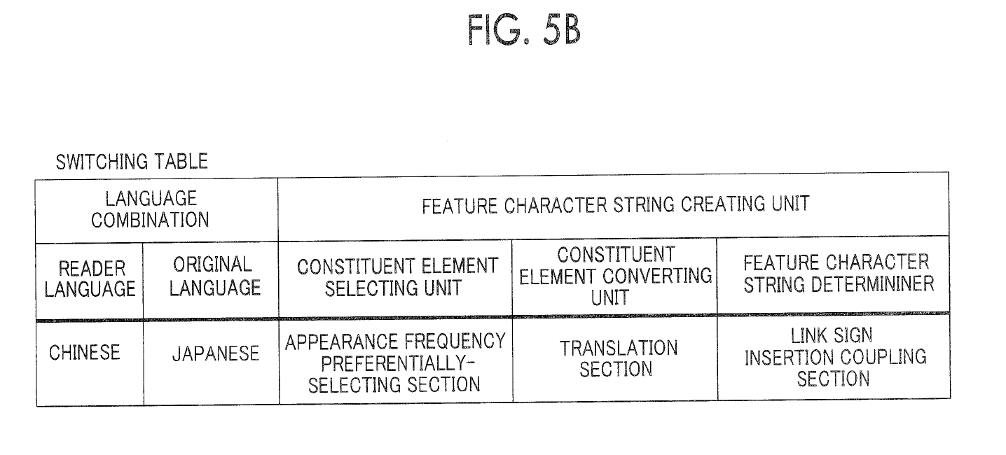

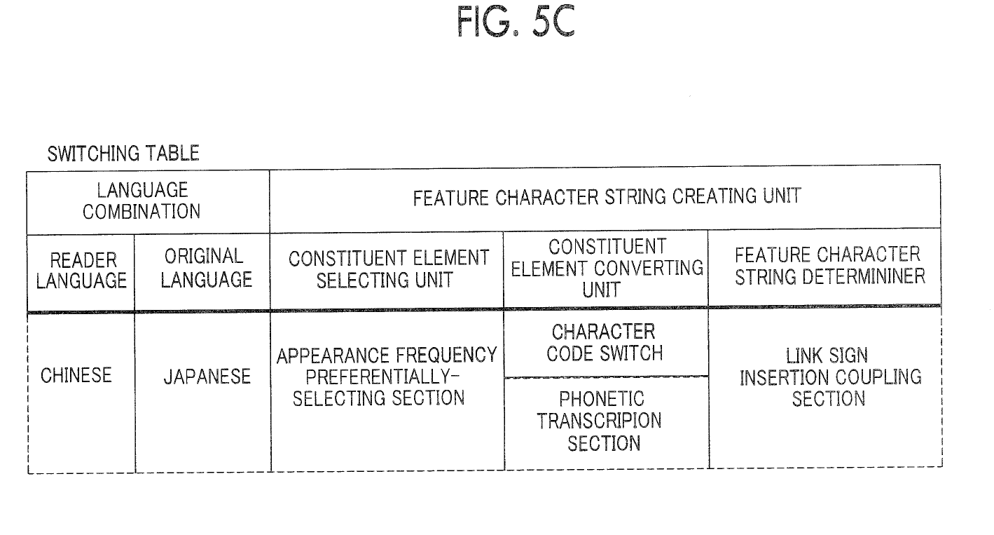

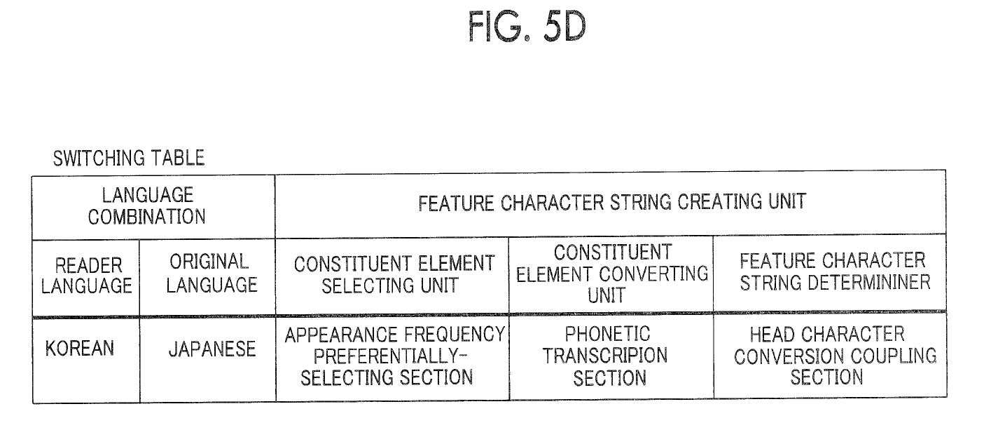

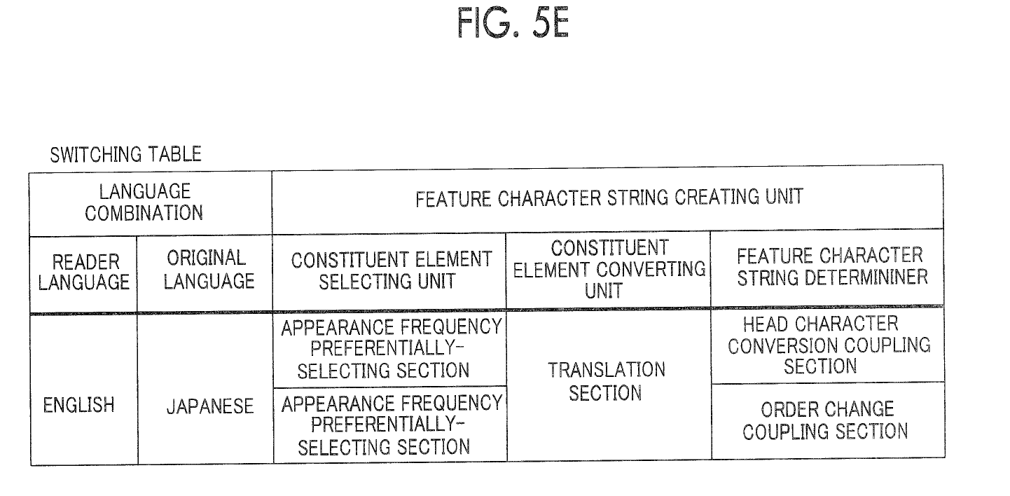

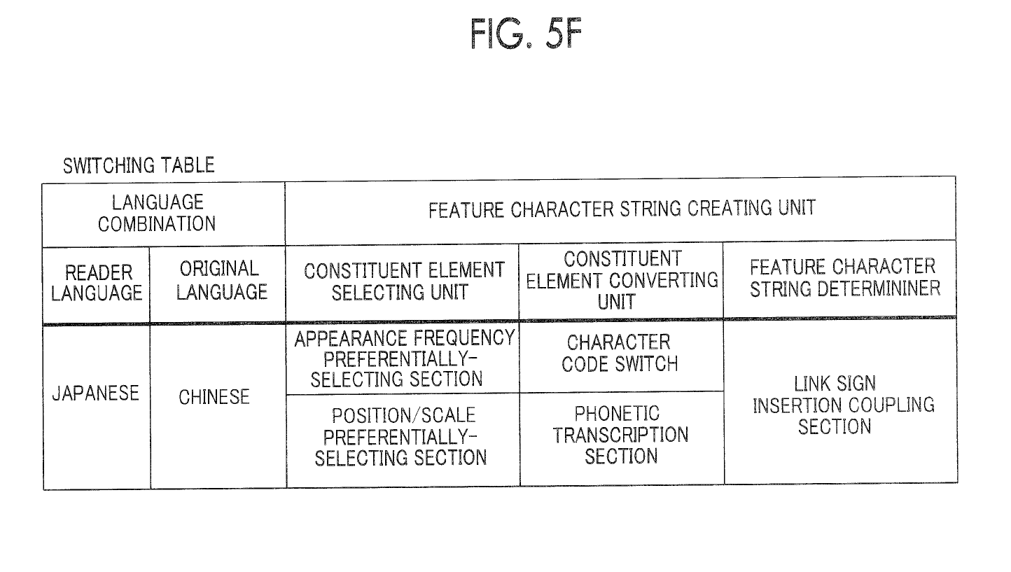

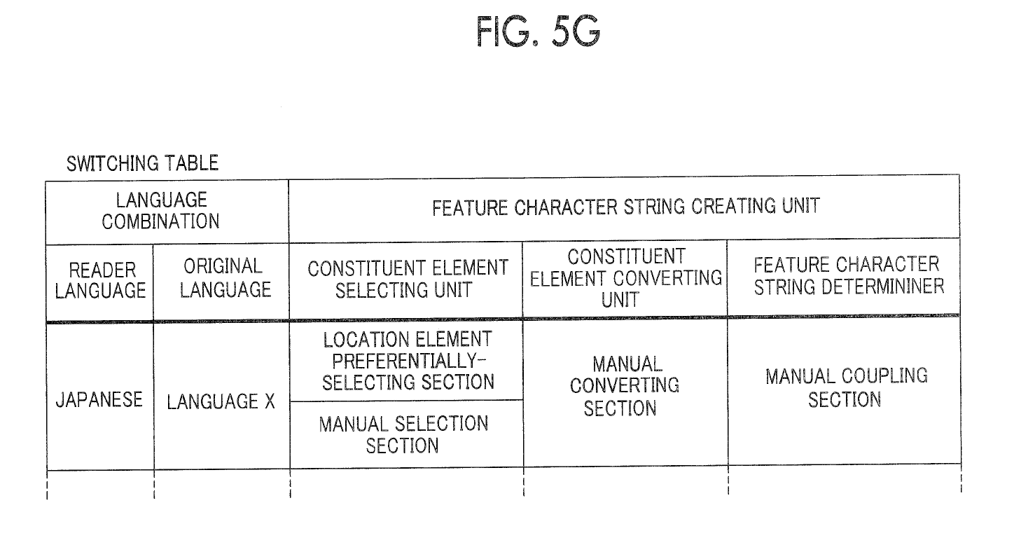

Specifically, the switching unit 326 controls the constituent selecting unit 42, the constituent converting unit 44, and the feature character string determining unit 46 of the feature character string creating unit 40 to switch the feature character string creating sections used to create a feature character string on the basis of the language combination information and a switching table (to be described later with reference to FIGS. 5A to 5G).

FIGS. 5A to 5G are diagrams illustrating the switching table.

The switching table indicates the correspondence between language combinations and the feature character string creating sections of the constituent selecting unit 42, the constituent converting unit 44, and the feature character string determining unit 46 of the feature character string creating unit 40 used to create a feature character string.

The switching table may be stored in advance in the image processing apparatus 2 or may be appropriately corrected by a user's operation on the UI device 25.

In the example shown in FIGS. 5A to 5G, for example, in case of the combination in which the reader language is Japanese and the original language is Japanese (case shown in FIG. 5A), the switching unit 326 switches the constituent selecting unit 42 of the feature character string creating unit 40 to the appearance frequency preferentially-selecting section 420 and the complex character string preferentially-selecting section 424, switches the constituent converting unit 44 to the non-conversion section 446, and switches the feature character string determining unit 46 to the link sign insertion coupling section 460.

In the example shown in FIGS. 5A to 5G, in case of the combination in which the reader language is Chinese and the original language is Japanese (case shown in FIG. 5B), the switching unit 326 switches the constituent selecting unit 42 of the feature character string creating unit 40 to the appearance frequency preferentially-selecting section 420, switches the constituent converting unit 44 to the translation section 440, and switches the feature character string determining unit 46 to the link sign insertion coupling section 460.

As in cases shown in FIGS. 5A, 5E, 5F, and 5G, the switching unit 326 may control the feature character string creating unit 40 so as to use plural feature character string creating sections of the constituent selecting unit 42.

Similarly, the switching unit 326 may control the feature character string creating unit 40 to use plural feature character string creating sections of the constituent converting unit 44 as in cases shown in FIGS. 5C and 5F, or may control the feature character string creating unit 40 to use plural feature character string creating sections of the feature character string determining unit 46 as in case shown in FIG. 5E.

In the feature character string creating unit 40 (FIGS. 2 and 3), the feature character string creating section used to create a feature character string is switched by the switching unit 326 and the feature character string is then created using the switched feature character string creating section.

The constituent selecting unit 42 extracts a character string list from the extracted character string managing unit 312, selects one or more character strings (hereinafter, simply referred to as “constituent”) which are constituents of the feature character string from the character strings included in the character string list, and outputs the selected constituents to the constituent converting unit 44.

Specifically, the constituent selecting unit 42 selects a predetermined number of character strings (corresponding to the number of constituents) sequentially from the largest weighting factor given to the character strings by the use of one or more feature character string creating sections set by the switching unit 326 out of the feature character string creating sections of the constituent selecting unit 42.

The number of character strings selected by the constituent selecting unit 42 may be constant regardless of the language combination, or may be appropriately switched depending on the language combination.

When a constituent which cannot be converted by the switched feature character string creating section of the constituent converting unit 44 is present among the selected constituents (for example, when the constituent is a special Chinese word), the constituent selecting unit 42 may select the character string having the largest weighting factor out of the character strings not selected as a constituent instead of the constituent which cannot be converted.

The appearance frequency preferentially-selecting section 420 gives decreasing weighting factors to the character strings included in the character string list sequentially from the character string having the highest appearance frequency.

For example, when the appearance frequency of the character string “fukugouki” is the highest, the appearance frequency of the character string “hanbai” is the second highest, and the appearance frequency of the character string “denpyo” is the third highest, the appearance frequency preferentially-selecting section 420 gives a weighting factor 10.0 to the character string “fukugouki”, gives a weighting factor 8.0 to the character string “hanbai”, and gives a weighting factor 6.0 to the character string “denpyo”.

The appearance frequency preferentially-selecting section 420 may give a weighting factor to a character string on the basis of the appearance frequency (the number of appearances) of the character string instead of the ranking of appearance frequency of the character string.

When the character string extracting unit 310 gives a weighting factor, the appearance frequency preferentially-selecting section 420 may change the weighting factor given by the character string extracting unit 310 on the basis of a predetermined criterion.

The criterion for allowing the appearance frequency preferentially-selecting section 420 to give a weighting factor may be constant regardless of the language combination or may be appropriately switched depending on the language combination.

The reader language preferentially-selecting section 422 increases the weighting factor of a character string by a predetermined value, when the character string to which the character string language information indicating the same language as the reader language is given is present among the character strings included in the character string list.

For example, the reader language preferentially-selecting section 422 may multiply the weighting factor of the character string to which the character string language information indicating the same language as the reader language is given by a predetermined value (for example, double the weighting factor) or may add a predetermined value to the weighting factor (for example, add 2.0 thereto).

The reader language preferentially-selecting section 422 may treat, for example, a character string in which an English word is transcribed in the Katakana characters (for example, a character string “proguram” which is a Katakana transcription of an English word “program”) as English, when the character strings are not the same language as the reader language, for example, when the reader language is English and the original language is Japanese.

The complex character string preferentially-selecting section 424 increases the weighting factor of a character string by a predetermined value, when the character string to which the complex character string information indicating a complex character string is given is present among the character strings included in the character string list.

For example, the complex character string preferentially-selecting section 424 may multiply the weighting factor of the character string to which the complex character string information is given by a predetermined value (for example, multiply it by 5) or may add a predetermined value to the weighting factor (for example, add 5.0 thereto).

When the weighting factor of a complex character string is equal to or greater than the weighting factors of the character strings constituting the complex character string, the complex character string preferentially-selecting section 424 may delete the character strings of the complex character string so as not to be selected as a constituent.

The position/scale preferentially-selecting section 426 increases the weighting factor of a character string present at a predetermined position in the original or a character string having a predetermined scale by a predetermined value, similarly to the reader language preferentially-selecting section 422.

For example, the position/scale preferentially-selecting section 426 increases the weighting factor of a character string by a predetermined value, when the character string is positioned higher in the vertical direction than a predetermined position in the original and is positioned in the horizontal direction within a predetermined range from the center of the original.

For example, the position/scale preferentially-selecting section 426 increases the weighting factor of a character string by a predetermined value, when the scale of the character string is equal to or greater than a predetermined value.

The position/scale preferentially-selecting section 426 may gradually increase the weighting factor of a character string depending on the position or scale of the character string.

When the location analyzing unit 304 determines that a predetermined location element is included in the original, the location element preferentially-selecting section 428 selects a character string indicating a location element (a location element character string) and gives a predetermined weighting factor to the location element character string.

For example, the location element preferentially-selecting section 428 selects a location element character string “photograph” and gives a predetermined weighting factor thereto, when a location element “photograph” is included in the original (even when the character string “photograph” is not extracted by the character string extracting unit 310).

The criterion for determining a weighting factor to be given to a location element by the location element preferentially-selecting section 428 and a location element to which a weighting factor should be given may be constant regardless of the language combination or may be appropriately switched depending on the language combination.

The location element character string may be a character string of a reader language.

The manual selection section 430 causes the UI device 25 to display a message for urging a user to select a constituent and receives the character string selected (input) by a user's operation on the UI device 25.

The manual selection section 430 may control the UI device 25 to cause a user to input a character string not included in the character string list. In this case, the manual selection section 430 may control the UI device 25 to cause a user to input a character string of the reader language.

The criteria for causing the reader language preferentially-selecting section 422, the complex character string preferentially-selecting section 424, and the position/scale preferentially-selecting section 426 to increase the weighting factor by a predetermined value may be constant regardless of the language combination or may be appropriately switched depending on the language combination.

It is stated in the exemplary embodiment that the reader language preferentially-selecting section 422, the complex character string preferentially-selecting section 424, and the position/scale preferentially-selecting section 426 increase the weighting factors given to the character strings by the appearance frequency preferentially-selecting section 420, but the reader language preferentially-selecting section 422, the complex character string preferentially-selecting section 424, and the position/scale preferentially-selecting section 426 may perform the process independently of the appearance frequency preferentially-selecting section 420.

That is, for example, when the number of character strings in the reader language is equal to or larger than the number of constituents, the reader language preferentially-selecting section 422 may select only the character strings in the reader language as a constituent regardless of the appearance frequency.

For example, when the number of character strings in the reader language is less than the number of constituents, the reader language preferentially-selecting section 422 may give the maximum weighting factor to the present character strings in the reader language to select the character strings as a constituent and the appearance frequency preferentially-selecting section 420 may select the other constituents.

The constituent converting unit 44 converts the constituents selected by the constituent selecting unit 42 by the use of one or more feature character string creating sections switched by the switching unit 326 out of the feature character string creating sections of the constituent converting unit 44.

The constituent converting unit 44 outputs the converted constituents to the feature character string determining unit 46.

The translation section 440 translates the constituents into the reader language, for example, by the use of a previously-stored translation dictionary.

Here, the translation dictionary is information (database) used to translate the original language into the reader language and stores character strings in the reader language corresponding to (having the same meanings as the original language) character strings in the original language in correlation with each other.

For example, when the reader language is English, the original language is Japanese, the selected constituent is “goukei”, and the Japanese character string “goukei” is correlated with an English character string “total” in the translation dictionary, the translation section 440 translates the constituent “goukei” into “total”.

The phonetic transcription section 442 converts the pronunciation of a constituent into, for example, predetermined character codes (pronunciation character codes) expressing the European characters (alphanumeric characters and predetermined symbols) or the like by using, for example, a prestored pronunciation dictionary and transcribes the constituent in characters expressed by the character codes.

Here, the pronunciation character codes are character codes expressing a character using 1 byte (the minimum data unit treated by a computer), such as ASCII.

Here, the pronunciation dictionary is information (database) used to transcribe the original language in the pronunciation corresponding to the pronunciation character codes and stores character strings in the original language and character strings in which the pronunciation corresponding to the character strings in the original language is transcribed by the use of the pronunciation character codes in correlation with each other.

For example, when the selected constituent is “goukei”, the phonetic transcription section 442 transcribes the constituent “goukei” as Roman characters (European characters) “goukei”.

The character code converting section 444 converts the character codes expressing a constituent into corresponding different character codes which can be recognized in the reader environment, for example, using a conversion table stored in advance and transcribes the constituent in characters expressed by the converted character codes.

Here, for example, a constituent is in a Chinese character, the conversion table shows the correspondence of the character codes (character codes used to transcribe Chinese characters having the same meaning but having different transcriptions) of the Chinese character in Chinese, Japanese, and Korean.

For example, the conversion table shows the correspondence in which a Chinese character is expressed in a character code Big5 in Chinese and is expressed in a character code Shift JIS in Japanese.

The conversion table also shows the correspondence between character codes of character strings as a constituent and character codes corresponding to the character strings, such as Unicode unifying and transcribing character strings in universal languages.

The non-conversion section 446 does not perform any conversion process on a constituent and outputs the constituent to the feature character string determining unit 46, for example, when the reader language and the original language are the same.

The manual conversion section 448 controls the UI device 25 to display a message for causing a user to convert a constituent, receives a character string converted by a user's operation on the UI device 25 as a constituent, and outputs the constituent to the feature character string determining unit 46.

The feature character string determining unit 46 determines a feature character string by coupling the constituents (including the constituents not converted by the non-conversion section 446) converted by the constituent converting unit 44 by the use of one or more feature character string creating sections set by the switching unit 326 among the feature character string creating sections of the feature character string determining unit 46.

The feature character string determining unit 46 performs a process of causing the UI device 25 to display the determined feature character string.

The feature character string determining unit 46 may perform a process so that a user can correct the feature character string through the use of the UI device 25, when causing the UI device 25 to display the determined feature character sting.

The order change coupling section 466 performs a process of changing the converted constituents to the order corresponding to the grammar of the reader language on the basis of the combination of the reader language and the original language and coupling the constituents in the changed order.

For example, the order change coupling section 466 changes the order of the converted constituents to the order corresponding to the grammar of the reader language through the use of the morpheme analysis process.

When the order change coupling section 466 is not used, the order of the constituents in the feature character string may be the same as the order (that is, the order decreasing the weighting factor) selected by the constituent selecting unit 42.

The link sign insertion coupling section 460 performs a process of inserting a link sign such as “_” (under-bar) between the constituents when coupling the converted constituents.

The head character conversion coupling section 462 performs a process of converting the head character of each constituent into a character corresponding to the head character when coupling the converted constituents.

For example, when the converted constituents are in European characters, the head character conversion coupling section 462 converts the head characters of the constituents into upper case characters from lower case characters.

The non-conversion coupling section 464 performs a process of coupling the constituents without performing any conversion process on the constituents when coupling the converted constituents.

The manual coupling section 468 causes the UI device 25 to display a message for causing a user to insert any sign between the constituents and to couple the constituents in an order and determines a character string, which is determined by a user's operation on the UI device 25, as the feature character string.

The processes of the feature character string creating unit 40 in the example shown in FIGS. 5A to 5G will be described case by case.

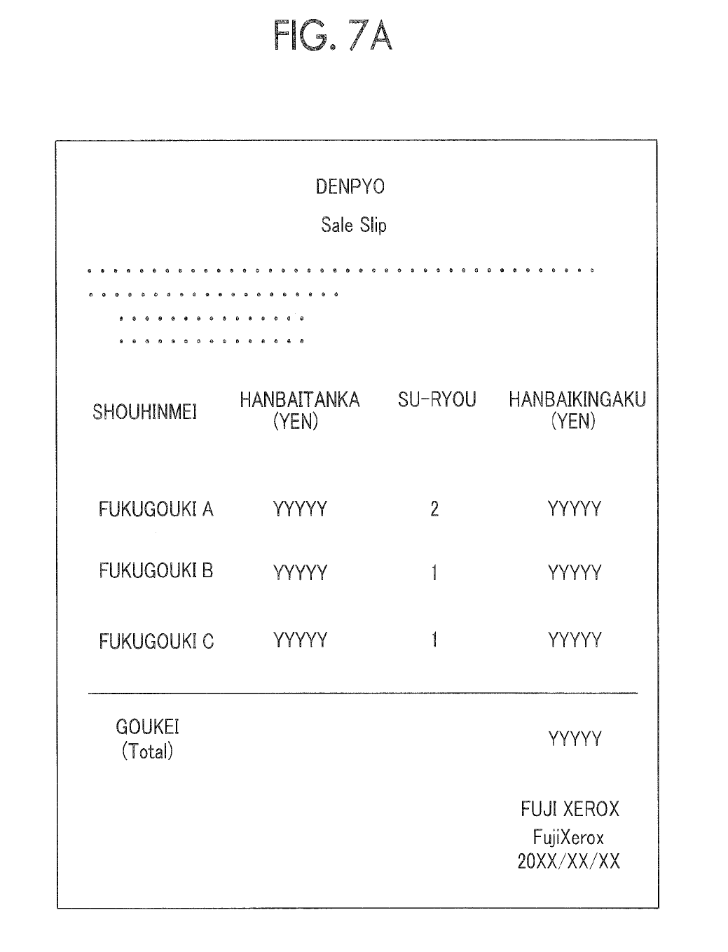

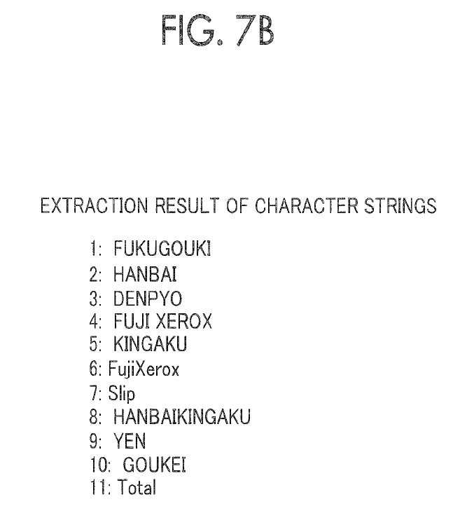

Cases where the original language is Japanese and the reader language is Japanese, Chinese, and Korean (the cases shown in FIGS. 5A to 5D) will be specifically described later with reference to FIGS. 7A and 7B and FIGS. 8 to 11.

In the case where the reader language is English and the original language is Japanese (the case shown in FIG. 5E), the switching unit 326 switches the constituent selecting unit 42 to the appearance frequency preferentially-selecting section 420 and the reader language preferentially-selecting section 422, switches the constituent converting unit 44 to the translation section 440, and switches the feature character string determining unit 46 to the head character conversion coupling section 462 and the order change coupling section 466.

The appearance frequency preferentially-selecting section 420 sequentially gives the weighting factors to the character strings included in the character string list so that a character string having a higher appearance frequency has a higher weighting factor.

The reader language preferentially-selecting section 422 increases the weighting factor given to the character string in English by the appearance frequency preferentially-selecting section 420 by a predetermined value, when a character string in English as the reader language is present in the character string list.

The constituent selecting unit 42 selects as constituents character strings corresponding to a predetermined number of constituents sequentially from the highest weighting factor out of the character strings to which the weighting factors are given through the use of the above-mentioned process.

The translation section 440 translates the constituents selected by the constituent selecting unit 42 from Japanese to English.

The translation section 440 may not translate the constituents of which the original language is English.

The head character conversion coupling section 462 converts the head character of each constituent translated in English from a lower case character to an upper case character.

The order change coupling section 466 arranges the constituents translated in English in the order corresponding to the English grammar.

The feature character string determining unit 46 couples the constituents, the header characters of which have been converted into upper case characters and which have been arranged to correspond to the English grammar, to determine a feature character string.

In the case where the reader language is Japanese and the original language is Chinese (the case shown in FIG. 5F), the switching unit 326 switches the constituent selecting unit to the appearance frequency preferentially-selecting section 420 and the position/scale preferentially-selecting section 426, switches the constituent converting unit 44 to the character code converting section 444 and the phonetic transcription section 442, and switches the feature character string determining unit 46 to the link sign insertion coupling section 460.

The appearance frequency preferentially-selecting section 420 sequentially gives the weighting factors to the character strings included in the character string list so that a character string having a higher appearance frequency has a higher weighting factor.

The position/scale preferentially-selecting section 426 increases the weighting factor given to the character string by a predetermined value, when the character string is located higher in the vertical direction than a predetermined position in the original and is positioned within a predetermined range from the center in the original in the horizontal direction and the scale of the character string is equal to or greater than a predetermined value.

The constituent selecting unit 42 selects as constituents the character strings corresponding to a predetermined number of constituents sequentially from the highest weighting factor out of the character strings to which the weighting factors are given through the use of the above-mentioned process.

The character code converting section 444 converts character codes of a constituent expressed in Chinese character codes into Japanese character codes and transcribes the constituent in characters expressed in the converted character codes.

The phonetic transcription section 442 converts the pronunciation of the Chinese constituent as for a constituent having no Japanese character code into the pronunciation character codes and transcribes the constituent as characters expressed by the pronunciation character codes.

The link sign insertion coupling section 460 couples the converted constituents, which are arranged in the order (that is, in the descending order in weighting factors) selected by the constituent selecting unit 42, with a link sign inserted therebetween to determine a feature character string.

In the case where the reader language is Japanese and the original language is language X (the type of which cannot be identified) (the case shown in FIG. 5G), the switching unit 326 switches the constituent selecting unit 42 to the location element preferentially-selecting section 420 and the manual selection section 430, switches the constituent converting unit 44 to the manual conversion section 448, and switches the feature character string determining unit 46 to the manual coupling section 468.

When the original includes a predetermined location element (for example, a photograph), the location element preferentially-selecting section 428 selects a location element character string (for example, character string “photograph”) and gives a predetermined weighting factor to the location element character string.

The manual selection section 430 controls the UI device 25 to allow a user to input a character string.

The constituent selecting unit 42 selects the character string (the location element character string) selected by the location element preferentially-selecting section 420 and the character string received by the manual selection section 430 as the operation result on the UI device 25 as the constituents.

The manual conversion section 448 causes the UI device 25 to display a message for causing a user to convert a constituent and receives as the constituent a character string converted by the user's operation on the UI device 25.

When the constituents selected by the constituent selecting unit 42 are expressed in the reader language, the user need not operate the UI device 25 to perform the conversion process.

The manual coupling section 468 causes the UI device 25 to display a message for causing the user to insert a sign between the constituents to couple the constituents in an arbitrary order and determines as a feature character string the character string determined by the user's operation on the UI device 25.

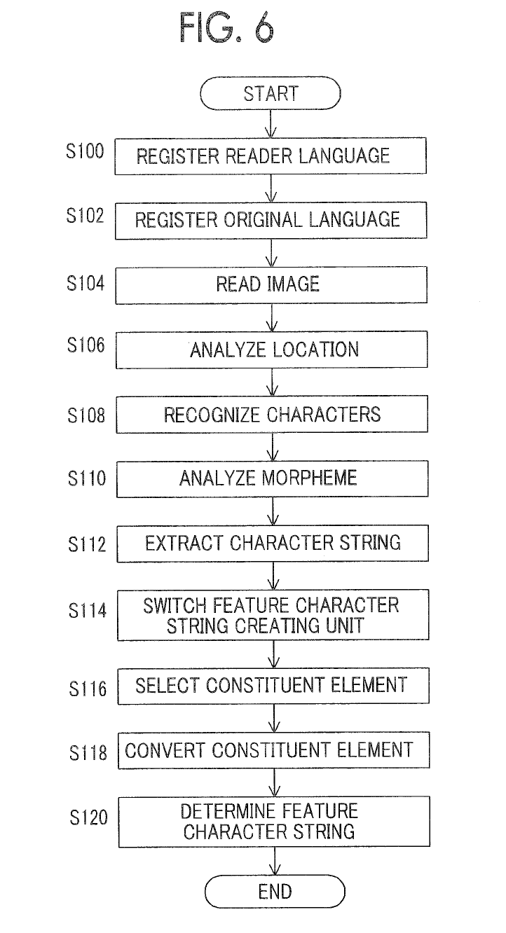

FIG. 6 is a flowchart (S10) illustrating the flow of processes of the processing program 3.

In step 100 (S100), the reader language registering unit 320 registers a reader language.

In step 102 (S102), the original language registering unit 322 registers an original language.

In step 104 (S104), the original reading information receiving unit 302 receives the original reading information acquired from the image reading device 27.

In step 106 (S106), the location analyzing unit 304 analyzes the original reading information, specifies areas of the location elements in the original, and creates location information.

In step 108 (S108), the character recognizing unit 306 recognizes characters in the character areas specified from the location information and creates character data.

In step 110 (S110), the morpheme analyzing unit 308 performs a morpheme analysis process on the character data recognized by the character recognizing unit 306 and gives attribute information to the morphemes (character strings).

In step 112 (S112), the character string extracting unit 310 extracts the character string, to which predetermined specific attribute information is given, from the character string group received from the morpheme analyzing unit 308.

In step 114 (S114), the switching unit 326 switches the feature character string creating sections used to create a feature character string in the feature character string creating unit 40 on the basis of the language combination information.

In step 116 (S116), the constituent selecting unit 42 gives weighting factors to the character strings included in the character string list by the use of one or more feature character string creating sections set by the switching unit 326 and selects as constituents the character strings corresponding to the number of constituents sequentially from the character string having the largest weighting factor.

In step 118 (S118), the constituent converting unit 44 converts the selected constituents by the use of one or more feature character string creating sections set by the switching unit 326 out of the feature character string creating sections of the constituent converting unit 44.

In step 120 (S120), the feature character string determining unit 46 determines a feature character string by coupling the converted constituents by the use of one or more feature character string creating sections set by the switching unit 326 out of the feature character string creating sections of the feature character string determining unit 46.

The flow of processes of the image processing apparatus 2 according to this exemplary embodiment will be described below with reference to specific examples.

FIGS. 7A and 7B are diagrams illustrating an example of an original to be processed by the image processing apparatus 2 according to this exemplary embodiment and an example of the character string extraction result, where FIG. 7A shows an example of the original and FIG. 7B shows an example of the character string extraction result.

Since the original shown in FIG. 7A is mainly transcribed in Japanese, the original language is Japanese.

Character strings are extracted in the order shown in FIG. 7B through the use of the process of the character string extracting unit 310 on the basis of the original.

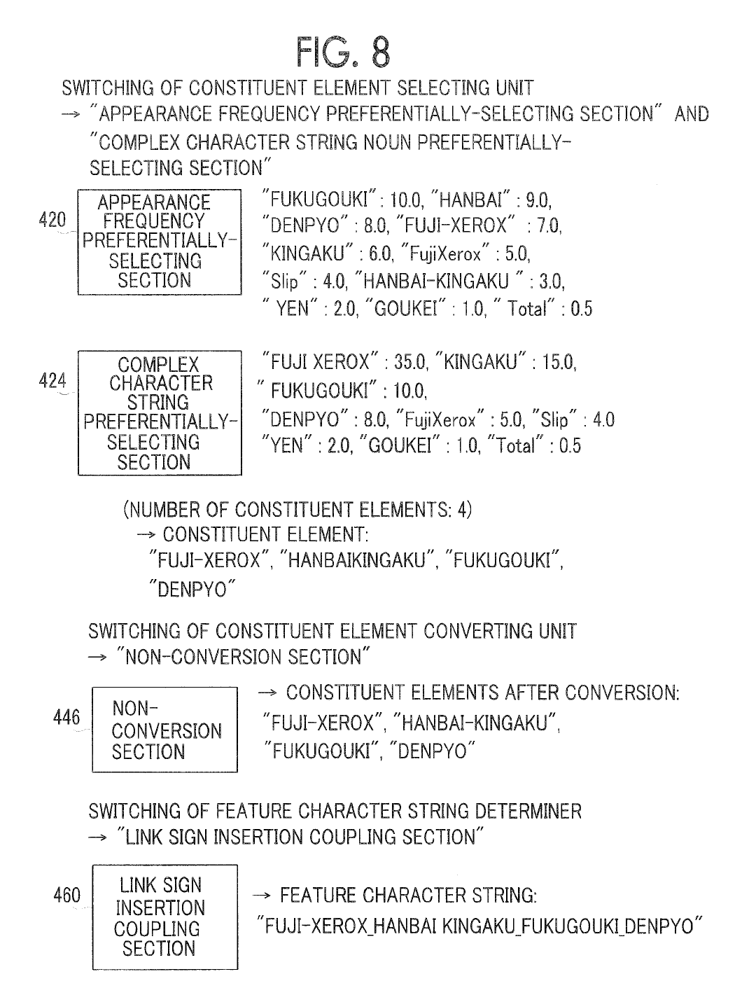

FIG. 8 is a diagram illustrating the flow of processes of the feature character string creating unit 40 in the case where the reader language of the original shown in FIGS. 7A and 7B is Japanese.

The case shown in FIG. 8 corresponds to the case shown in FIG. 5A.

In this case, the switching unit 326 switches the constituent selecting unit 42 to the appearance frequency preferentially-selecting section 420 and the complex character string preferentially-selecting section 424, switches the constituent converting unit 44 to the non-conversion section 446, switches the feature character string determining unit 46 to the link sign insertion coupling section 460.

The appearance frequency preferentially-selecting section 420 gives the weighting factors to the character strings shown in FIG. 7B sequentially from the character string having the highest appearance frequency as shown in FIG. 8.

The complex character string preferentially-selecting section 424 increases the weighting factors of the complex character strings “fujixerox” and “hanbaikingaku” to five times as shown in FIG. 8.

Since the weighting factor of the character string “hanbai” is 9.0 and the weighting factor of the character string “kingaku” is 6.0 but the character strings “hanbai” and “kingaku” are included in the complex character string “hanbaikingaku” having a larger weighting factor, the character strings “hanbai” and “kingaku” are deleted.

When the number of constituents is 4, the constituent selecting unit 42 selects four high-ranked character strings “fujixerox”, “hanbaikingaku”, “fukugouki”, and “denpyo” having larger weighting factors as the constituents.

The non-conversion section 446 does not perform a conversion process on the constituents “fujixerox”, “hanbaikingaku”, “fukugouki”, and “denpyo”.

The link sign insertion coupling section 460 inserts a link sign “_” between the constituents and couples the constituents to create the feature character string shown in FIG. 8.

Here, wherein the character string “fujixerox_hanbaikingaku_fukugouki_denpyo” is displayed by PCs of readers of which the reader languages are Chinese and Korean, the Japanese character codes are hardly set up in the PCs. Accordingly, the character string is not correctly displayed and so-called character corruption occurs.

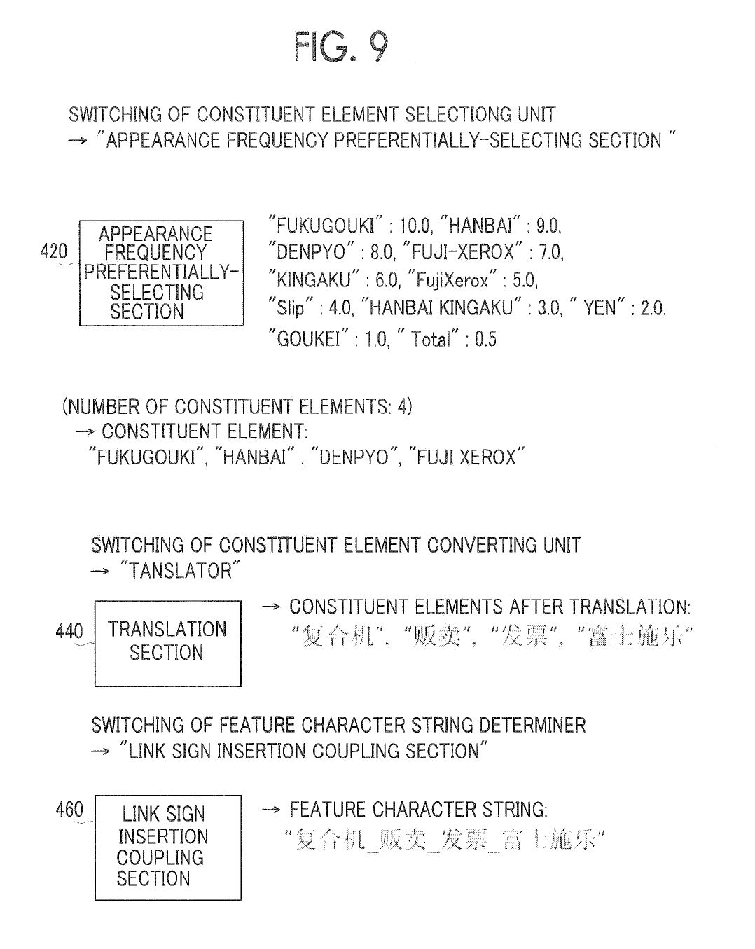

FIG. 9 is a diagram illustrating the flow of processes of the feature character string creating unit 40 in the case where the reader language of the original shown in FIGS. 7A and 75 is Chinese.

The case shown in FIG. 9 corresponds to the case shown in FIG. 55.

In this case, the switching unit 326 switches the constituent selecting unit 42 to the appearance frequency preferentially-selecting section 420, switches the constituent converting unit 44 to the translation section 440, switches the feature character string determining unit 46 to the link sign insertion coupling section 460.

The appearance frequency preferentially-selecting section 420 gives the weighting factors to the character strings shown in FIG. 7B sequentially from the character string having the highest appearance frequency as shown in FIG. 9.

When the number of constituents is 4, the constituent selecting unit 42 selects four high-ranked character strings “fukugouki”, “hanbai”, “denpyo”, and “fujixerox” having larger weighting factors as the constituents.

The translation section 440 translates the constituents “fukugouki”, “hanbai”, “denpyo”, and “fujixerox” into Chinese.

The link sign insertion coupling section 460 inserts a link sign “_” between the translated constituents and couples the constituents to create the feature character string shown in FIG. 9.

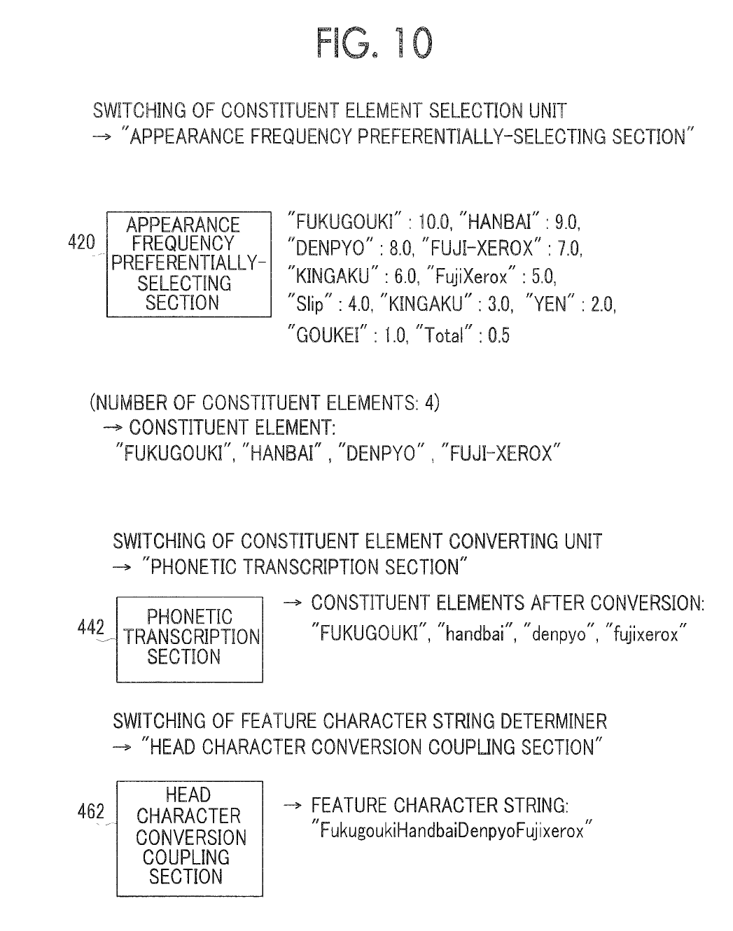

FIG. 10 is a diagram illustrating the flow of processes of the feature character string creating unit 40 in the case where the reader language of the original shown in FIGS. 7A and 7B is Korean.

The case shown in FIG. 10 corresponds to the case shown in FIG. 5D.

In this case, the switching unit 326 switches the constituent selecting unit 42 to the appearance frequency preferentially-selecting section 420, switches the constituent converting unit 44 to the phonetic transcription section 442, switches the feature character string determining unit 46 to the head character conversion coupling section 462.

The appearance frequency preferentially-selecting section 420 gives the weighting factors to the character strings shown in FIG. 7B sequentially from the character string having the highest appearance frequency as shown in FIG. 10.

When the number of constituents is 4, the constituent selecting unit 42 selects four high-ranked character strings “fukugouki”, “hanbai”, “denpyo”, and “fujixerox” having larger weighting factors as the constituents.

The phonetic transcription section 442 converts the constituents “fukugouki”, “hanbai”, “denpyo”, and “fujixerox” into characters (Roman characters) transcribing the pronunciation thereof as shown in FIG. 10.

The head character conversion coupling section 462 converts the head characters of the converted constituents into capital characters and then couples the constituents to create the feature character string shown in FIG. 10.

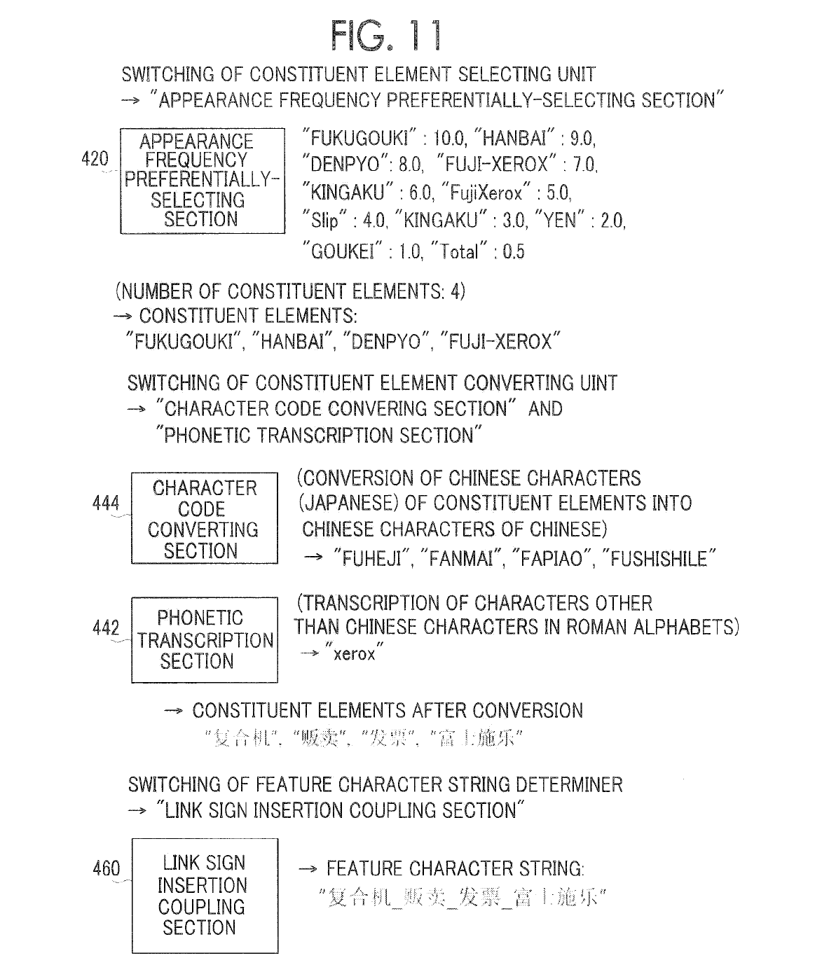

FIG. 11 is a diagram illustrating the flow of processes of the feature character string creating unit 40 in the case where the reader language of the original shown in FIGS. 7A and 7B is Chinese.

The case shown in FIG. 11 corresponds to the case shown in FIG. 5C.

In this case, the switching unit 326 switches the constituent selecting unit 42 to the appearance frequency preferentially-selecting section 420, switches the constituent converting unit 44 to the phonetic transcription section 442 and the character code converting section 444, switches the feature character string determining unit 46 to the link sign insertion coupling section 460.

The appearance frequency preferentially-selecting section 420 gives the weighting factors to the character strings shown in FIG. 73 sequentially from the character string having the highest appearance frequency as shown in FIG. 11.

When the number of constituents is 4, the constituent selecting unit 42 selects four high-ranked character strings “fukugouki”, “hanbai”, “denpyo”, and “fujixerox” having larger weighting factors as the constituents.

The character code converting section 444 converts the character codes (for example, the shift JIS) transcribing the Chinese characters of the constituents into the corresponding Chinese character codes (for example, the Big5) and transcribes the constituents in the characters expressed by the converted character codes, as shown in FIG. 11.

The phonetic transcription section 442 converts the character string “Xerox” having no corresponding Chinese character code into characters transcribing the pronunciation thereof as shown in FIG. 11.

The link sign insertion coupling section 460 inserts a link sign “_” between the converted constituents and couples the constituents to create the feature character string shown in FIG. 11.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention, be defined by the following claims and their equivalents.

What is claimed is:

1. An image processing apparatus comprising:
a registering unit that registers a first language and a second language different from the first language;
a character string extracting unit that extracts one or more character strings from reading information acquired by reading an original;
a plurality of feature character string creating sections that create a feature character string of the original on the basis of the one or more character strings extracted by the character string extracting unit; and
a switching unit that switches the feature character string creating section used to create the feature character string on the basis of a combination of the registered first language and the registered second language.

2. The image processing apparatus according to claim 1, wherein the first language is a reader language that can be recognized by a reader of the original and the second language is an original language that is determined on the basis of the character strings appearing in the original.

3. The image processing apparatus according to claim 2, wherein the reader language is determined on the basis of identification information of the reader of the original and the original language is a language having a highest appearance ratio in the original.

4. The image processing apparatus according to claim 1, wherein the plurality of feature character string creating sections include:
a plurality of selection sections that perform a process of selecting one or more constituents constituting the feature character string of the original from the extracted one or more character strings on the basis of the combination of the first language and the second language; and
a plurality of feature character string determining sections that perform a process of determining the feature character string using the constituents selected by the selection sections, and
wherein the switching unit switches the selection section used to create the feature character string and switches the feature character string determining section used to create the feature character string on the basis of the combination of the first language and the second language.

5. The image processing apparatus according to claim 1, wherein the plurality of feature character string creating sections include:
a plurality of conversion sections that convert the one or more character strings extracted by the character string extracting unit on the basis of the combination of the first language and the second language; and
a plurality of feature character string determining sections that perform a process of determining the feature character string using the character strings converted by the conversion sections, and
wherein the switching unit switches the plurality of conversion sections and the plurality of feature character string determining sections used to create the feature character string on the basis of the combination of the first language and the second language.

6. The image processing apparatus according to claim 1, wherein the plurality of feature character string creating sections include:
a plurality of selection sections that perform a process of selecting one or more constituents of the feature character string of the original from the extracted one or more character strings on the basis of the combination of the first language and the second language;
a plurality of conversion sections that convert the one or more character strings selected by the selection sections on the basis of the combination of the first language and the second language; and
a plurality of feature character string determining sections that perform a process of determining the feature character string using the constituents converted by the conversion sections, and
wherein the switching unit switches the selection section used to create the feature character string, switches the conversion section used to create the feature character string, and switches the feature character string determining section used to create the feature character string on the basis of the combination of the first language and the second language.

7. The image processing apparatus according to claim 4, wherein one of the plurality of selection sections performs a process of selecting a constituent on the basis of an appearance frequency of the extracted one or more character strings in the original.

8. The image processing apparatus according to claim 4, wherein one of the plurality of selection sections sets a weighting factor for a first character string having at least one of a predetermined position and a predetermined scale among the extracted character strings to be higher by a predetermined value than a weighting factor for the extracted character strings other than the first character string, the weighting factor being an index for selecting the constituent from the extracted character strings.

9. The image processing apparatus according to claim 4, wherein one of the plurality of selection sections performs a process of selecting a second character string as the constituent, the second character string corresponding to a location element, the location element being disposed in and, constituting the original, and the location element being different from the character strings.

10. The image processing apparatus according to claim 4, wherein one of the plurality of selection sections sets a weighting factor for a third character string which is in the first language among the extracted character strings to be higher by a predetermined value than a weighting factor for the extracted character strings other than the third character string, the weighting factor being an index for selecting the constituent from the extracted character strings.

11. The image processing apparatus according to claim 5, wherein one of the plurality of conversion sections translates one or more of the extracted character strings into the first language.

12. The image processing apparatus according to claim 5, wherein one of the plurality of conversion sections converts one or more of the extracted character string into a character string transcribing pronunciations of the one or more character strings.

13. The image processing apparatus according to claim 5, wherein one of the plurality of conversion sections converts character codes of one or more of the extracted character strings into corresponding different character codes of the character strings.

14. A non-transitory computer-readable medium storing a program causing a computer to execute an image processing process, the process comprising:
registering a first language and a second language different from the first language;
extracting one or more character strings from reading information acquired by reading an original;
switching a feature character string creating section used to create the feature character string on the basis of a combination of the registered first language and the registered second language; and
creating the feature character string of the original using the switched feature character string creating section on the basis of the extracted one or more character strings.

15. An image processing method comprising:
registering a first language and a second language different from the first language;
extracting one or more character strings from reading information acquired by reading an original;
creating a feature character string of the original on the basis of the extracted one or more character strings; and
switching a feature character string creating section used to create the feature character string on the basis of a combination of the registered first language and the registered second language.
